(19) United States
(12) Patent Application Publication
(10) Pub. No.: US 2025/0358594 A1
(43) Pub. Date: Nov. 20, 2025

(54) METHOD AND DEVICE FOR BROADCAST RECEPTION INFORMATION IN MBS

(71) Applicant: SAMSUNG ELECTRONICS CO., LTD., Suwon-si, Gyeonggi-do (KR)

(72) Inventors: Sangkyu BAEK, Suwon-si (KR); Anil AGIWAL, Suwon-si (KR)

(21) Appl. No.: 18/872,602

(22) PCT Filed: Aug. 9, 2023
(86) PCT No.: PCT/KR2023/011781

§ 371 Date: Dec. 6, 2024

(30) Foreign Application Priority Data
Aug. 9, 2022 (KR) 10-2022-0099250

(51) Int. Cl. H04W 4/06

(52) U.S. Cl. CPC H04W 4/06

(57) ABSTRACT

The present disclosure relates to a 5G or 6G communication system for supporting a higher data transmission rate. An embodiment of the present invention provides operations of a UE and a base station in a situation in which the UE can be provided with an MBS in a non-serving cell. A method for operating a UE in a wireless communication system according to the present disclosure may comprise the steps of: receiving instruction information related to a broadcast service-related information report from a first base station corresponding to a serving cell of the UE; transmitting, to the first base station, UE capability information regarding whether a broadcast service can be received from a non-serving cell; and transmitting, to the first base station, information regarding a broadcast service which the terminal currently receives, or information regarding a broadcast service which the UE wishes to receive.

### TECHNICAL FIELD

The present disclosure relates to operations of UE and a base station in a mobile communication system, and more particularly, to controlling operations of UE and a base station in a situation in which the UE is able to receive an MBS from a non-serving cell.

### BACKGROUND ART

5G mobile communication technologies define broad frequency bands such that high transmission rates and new services are possible, and can be implemented not only in “Sub 6 GHz” bands such as 3.5 GHZ, but also in ultra-high frequency bands, “Above 6 GHz” bands referred to as mmWave such as 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), VR virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

The present invention is directed to controlling operations of UE and a serving base station in a situation in which the UE is able to receive a broadcast service from a non-serving cell, so that the UE and the base station operate more efficiently.

### Technical Solution

There is provided a method of operating UE in a wireless communication system, according to an embodiment of the present invention. The method may include: receiving, from a first base station corresponding to a serving cell of the UE, instruction information related to a broadcast service-related information report; transmitting, to the first base station, UE capability information on whether a broadcast service can be received from a non-serving cell; and transmitting, to the first base station, information on a broadcast service that the UE is receiving or information on a broadcast service that the UE wishes to receive.

There is provided a method of operating a base station in a wireless communication system, according to an embodiment of the present invention. The method may include: transmitting, to UE, instruction information related to a broadcast service-related information report; receiving, from the UE, UE capability information on whether a broadcast service can be received from a non-serving cell; and receiving, from the UE, information on a broadcast service that the UE is receiving or information on a broadcast service that the UE wishes to receive.

### Advantageous Effects

According to at least one of embodiments of the present invention, UE can report capability to receive a broadcast service from a non-serving cell and a reception state from another base station to a serving base station, and receive control from the serving base station over reception of the broadcast service through the other base station. Accordingly, the broadcast service can be delivered to the UE in a more efficient method.

### DESCRIPTION OF DRAWINGS

FIG. 1 is a view illustrating an example in which MBS broadcast communication is performed.

FIG. 2 is a view illustrating a method by which UE receives a broadcast service from a non-serving cell, according to an embodiment of the present disclosure.

FIG. 3 is a view illustrating a method by which UE reports broadcast service information from a non-serving cell to a serving base station, according to an embodiment of the present disclosure.

FIG. 4 is a view illustrating a method by which UE receives a broadcast service from a non-serving cell, according to an embodiment of the present disclosure.

FIG. 5 is a view illustrating a method by which UE receives a broadcast service from a cell of another PLMN, according to an embodiment of the present disclosure.

FIG. 6 is a view illustrating a method by which UE reports broadcast service information from another PLMN to a serving base station, according to an embodiment of the present disclosure.

FIG. 7 is a view illustrating a method by which UE receives a broadcast service from an inactive BWP according to an embodiment of the present disclosure.

FIG. 8 is a view illustrating a method by which UE reports broadcast service information from an inactive BWP to a serving base station, according to an embodiment of the present disclosure.

FIG. 9 is a view illustrating a structure of a base station according to an embodiment of the present invention.

FIG. 10 is a view illustrating a structure of UE according to an embodiment of the present invention.

### MODE FOR DISCLOSURE

When describing the embodiments in the present specification, a description of technical contents, which are well known in the technical field to which the present disclosure pertains but are not directly related to the present disclosure, will be omitted. This is to more clearly describe the subject matter of the present invention without obscuring the subject matter by omitting any unnecessary description.

Similarly, in the accompanying drawings, some constituent elements are illustrated in an exaggerated or schematic form or are omitted. In addition, a size of each constituent element does not entirely reflect an actual size. Like reference numerals designate like or corresponding constituent elements in the drawings.

Advantages and features of the present disclosure and methods of achieving the advantages and features will be clear with reference to exemplary embodiments described in detail below together with the accompanying drawings. However, the present disclosure is not limited to the exemplary embodiments disclosed herein but will be implemented in various forms. The exemplary embodiments of the present disclosure are provided so that the present disclosure is completely disclosed, and a person with ordinary skill in the art can fully understand the scope of the present disclosure. The present disclosure will be defined only by the scope of the appended claims. Throughout the specification, the same reference numerals denote the same constituent elements.

In this case, it will be understood that each block of processing flowchart illustrations and combination of flowchart illustrations may be performed by computer program instructions. These computer program instructions may be incorporated into a processor of a general purpose computer, a special purpose computer, or other programmable data processing equipment, such that the instructions executed by the processor of the computer or other programmable data processing equipment create means for performing the functions described in the flowchart block(s). These computer program instructions may also be stored in a computer usable or computer-readable memory that can direct a computer or other programmable data processing equipment to function in a particular manner, such that the instructions stored in the computer usable or computer-readable memory produce an article of manufacture including instruction means that performs the function described in the flowchart block(s). The computer program instructions may also be loaded onto a computer or other programmable data processing equipment to cause a series of operational steps to be performed on the computer or other programmable data processing equipment to produce a computer implemented process such that the instructions that execute on the computer or other programmable data processing equipment may provide steps for implementing the functions described in the flowchart block(s).

In addition, each block may represent a module, segment, or portion of code that includes one or more executable instructions for executing a specified logical function(s). Additionally, it should be noted that it is possible for the functions mentioned in the blocks to occur out of order in some alternative execution examples. For example, two blocks illustrated in succession may in fact be performed substantially simultaneously, or the blocks may sometimes be performed in a reverse order depending on the corresponding function.

In this case, the term such as a “unit” or a “portion” used in the present embodiments means a software constituent element or a hardware constituent element such as FPGA or ASIC, and the “unit” or the “portion” performs a certain role. However, the term ‘unit’, ‘part’, or ‘portion’ is not limited to software or hardware. The term ‘unit’, ‘part’, or ‘portion’ may be configured to be in an addressable storage medium or configured to reproduce one or more processors. Thus, as an example, the term ‘unit’, ‘part’, or ‘portion’ includes constituent elements such as software constituent elements, object-oriented software constituent elements, class constituent elements, and task components, processes, functions, properties, procedures, subroutines, segments of program codes, drivers, firmware, microcode, circuitry, data, database, data structures, tables, arrays, and variables. The functions provided in the constituent elements and the term, ‘units’, ‘parts’, or ‘portions’ may be combined into a smaller number of constituent elements, ‘units’, ‘parts’, and ‘portions’ and/or divided into additional constituent elements, ‘units’, ‘parts’, and ‘portions’. In addition, the constituent elements and ‘units’, ‘parts’, and ‘portions’ may be implemented to execute one or more CPUs within a device or secure multimedia card.

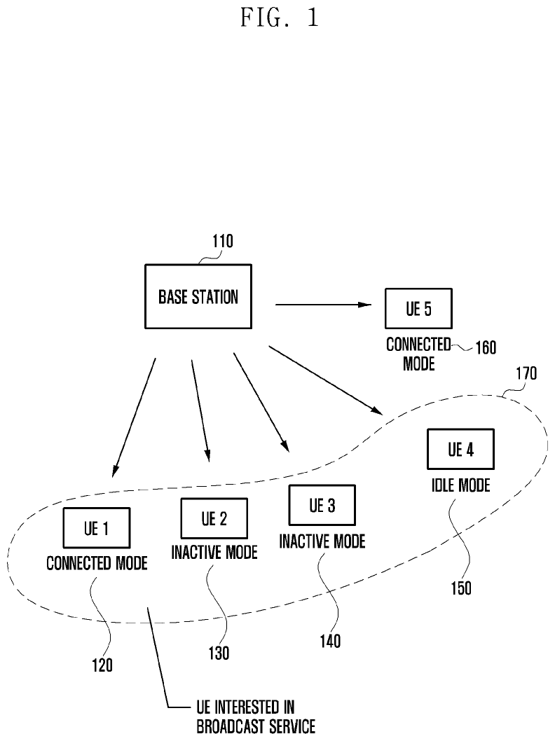

FIG. 1 is a view illustrating an operation method of a broadcast of MBS communication according to an embodiment of the present disclosure. The multicast and broadcast service (MBS) communication may refer to a method by which a single transmitting device in a mobile communication system communicates with an unspecified number of in-coverage receiving devices. Here, the transmitting device may be a base station, and each receiving device may be UE. However, the present disclosure is not limited to these examples and the transmitting device may be UE.

The embodiment of FIG. 1 illustrates an example of MBS broadcast communication being performed when a base station 110 is a transmitting device and UEs 120, 130, 140, 150, and 160 are receiving devices. In the broadcast, the base station 110 may transmit MBS radio bearer (MRB) configuration information for a broadcast service and a list of provided services to the UEs in a broadcast method. Since this broadcast information is not intended for specific UE, in-coverage UEs may receive this information, and when UE wishes to receive a specific broadcast service, the UE may receive the corresponding broadcast service. The embodiment of FIG. 1 illustrates a situation in which a base station is providing a specific broadcast service and specific UEs 120, 130, 140, and 150 are interested in or receiving the corresponding broadcast service. (170) In contrast, UE 5 160 may not have an interest of the UE in receiving the broadcast service provided by the base station, in which case the corresponding UE 5 160 may not receive the broadcast service.

UEs that wish to receive the broadcast service provided by the base station may store and be assigned a group-radio network temporary identity (G-RNTI), which is an identical separate resource identity from the broadcast configuration information of the base station, and receive data assigned to the corresponding G-RNTI. This G-RNTI corresponds to the corresponding broadcast service and is an RNTI shared by UEs receiving the corresponding broadcast service, and UEs that have received and stored the G-RNTI may receive radio resources for MBS services from the base station. This broadcast configuration information may be transmitted through an MBS control channel (MCCH). One or more broadcast services may be set in the coverage of the base station 110, and each broadcast service may correspond to the G-RNTI. One UE may be assigned one or more G-RNTIs from the base station 110. The UE may receive broadcast data not only in connected mode (RRC CONNECTED MODE), but also in idle mode (RRC IDLE MODE) or inactive mode (RRC INACTIVE MODE), using a G-RNTI value assigned in connected mode.

When the UE is receiving a specific broadcast service, or is interested in receiving a specific broadcast service, the UE may transmit the corresponding broadcast service information to the base station. This message may be referred to as an MBS interest indication (MII) message. The MII message may be transmitted to the base station by the UE in connected mode. The MII message may include a list of broadcast services that the UE is receiving, a list of broadcast services that the UE is interested in, or the like.

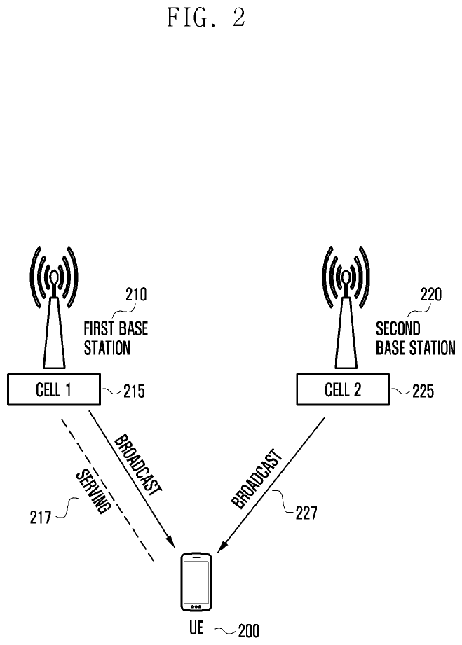

FIG. 2 is a view illustrating a method by which UE receives a broadcast service from a non-serving cell, according to an embodiment of the present disclosure.

The UE may be configured to include multiple radio receivers for an operation of performing transmission and reception while being simultaneously connected to multiple cells, such as carrier aggregation (CA) and dual connectivity. The UE may use multiple radio receivers as described above, and may receive a message transmitted by a non-serving cell that does not have a radio resource control (RRC) connection in a broadcast method when there is a usable receiver. The embodiment of FIG. 2 assumes that UE 200 is connected to cell 1 215 of a first base station 210 (217). That is, cell 1 is assumed to be a serving cell. The first base station may provide a broadcast service through cell 1, in which case the UE 200 may receive broadcast configuration information from cell 1, which is a serving cell, and receive the broadcast service. However, it may be difficult to receive the broadcast service from the serving cell when the serving cell of the UE does not provide a broadcast service of interest that the UE wishes to receive, the reception of the broadcast service is not smooth due to problems such as weak reception signal and the like, or the reception of the broadcast service is de-prioritized because the reception of a unicast service has a higher priority than the reception of the broadcast service. In this case, when the UE has a usable receiver, and a non-serving cell provides a broadcast service of interest that the UE wishes to receive, the UE may receive the corresponding broadcast service of interest from the non-serving cell (227). To this end, the UE may receive broadcast configuration information of the non-serving cell through a system information block or an MCCH channel. In this case, the UE may control that a portion of a receiver function is shared by unicast and broadcast reception from the serving cell and broadcast reception from the non-serving cell. For example, a HARQ process and a HARQ buffer used by the UE per cell may be shared by transmission and reception operations of a serving cell and reception operation of a non-serving cell.

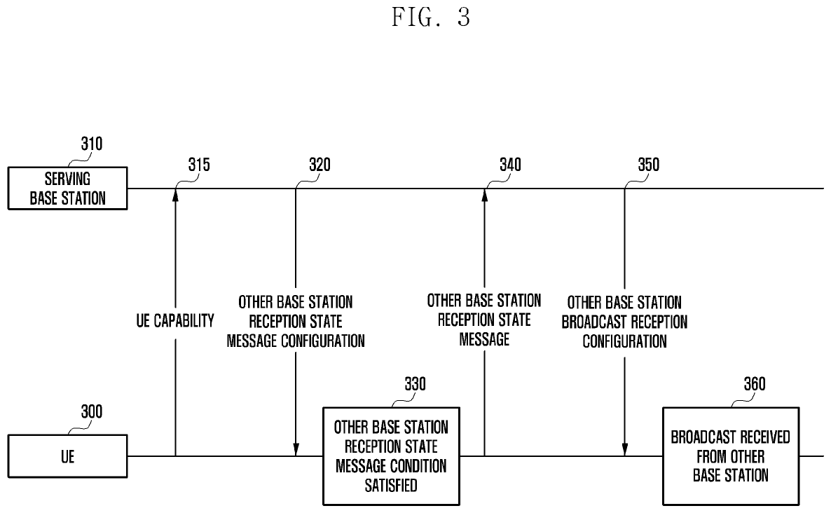

FIG. 3 is a view illustrating a method by which UE reports broadcast service information from a non-serving cell to a serving base station, according to an embodiment of the present disclosure.

As described in FIG. 2, when the UE has multiple radio receivers and there is a usable receiver capable of receiving a broadcast service from a non-serving cell, the UE may receive a broadcast service of interest from the non-serving cell. In this case, a serving base station to which the serving cell belongs may be aware of a list of broadcast services that the UE is currently receiving or is interested in receiving by means of MII messages transmitted by the base station and the like. The serving base station may reflect this and provide the corresponding broadcast service from the serving cell. However, when the UE receives this service from the non-serving cell, it may occur that the UE does not receive the broadcast service provided by the serving cell. This may be a waste of radio resources. To avoid this, the UE may transmit to the serving base station or serving cell a list of broadcast services that the UE is receiving or is interested in receiving from the non-serving cell.

UE 300 may transmit to a base station 310 a UE capability message indicating that the UE is capable of receiving a broadcast service from a non-serving cell, such as having a receiver capable of receiving a broadcast service from a non-serving cell (315). This message may include an indicator indicating that the UE may receive a broadcast message from a non-serving cell. The message may be in the form of a UE capability message, but may also be configured in the form of an MII message or a UE assistance information (UAI) message, depending on embodiments. The MII or UAI message may include information indicating that the broadcast service may be received from a non-serving cell. The base station may then request the UE to report on which broadcast service the UE is receiving from another base station, i.e., a non-serving cell, or which broadcast service of interest the UE may receive, and the like. This message may be referred to as an “other base station reception state message configuration” message (320). On this basis, the UE may identify whether the UE is satisfied with a triggering condition of the other base station reception state message (330). In contrast, the UE may trigger this message without going through step 315 or step 320, when there is a broadcast message that the UE is receiving from a non-serving cell, when a broadcast message of interest may be received from a non-serving cell, or when the triggering condition of the other base station reception state message is satisfied. The UE may then transmit the other base station reception state message to the serving base station (340). In an embodiment, the UE may trigger this message to transmit the other base station reception state message when the UE has not transmitted the other base station reception state message to the serving base station after having entered the connected mode. In another embodiment, the UE may trigger this message to transmit the other base station reception state message to the serving base station when information in the previously reported other base station reception state message has changed. For example, when UE was receiving a broadcast message from a non-serving cell, and the non-serving cell is no longer able to receive the broadcast message, the UE may transmit another base station reception state message to a serving base station. In another embodiment, the UE may transmit another base station reception state message to a serving base station when the UE detects a non-serving cell and there are broadcasts from the corresponding non-serving cell that the UE is interested in receiving, or when the UE has received a broadcast service from the corresponding non-serving cell. The other base station reception state message may be transmitted in the form of an MII message, UE assistance information or another RRC message. This other base station reception state message may include a list of broadcast services that are being received by the other base station or a list of broadcast services that are available for reception by the other base station. The list of broadcast services may be referred to as a temporary mobile group identity (TMGI). The other base station reception state message may include a cell identity of a non-serving cell to indicate that the non-serving cell is receiving, or is capable of receiving, the corresponding broadcast message. The cell identity may be a physical cell identity (PCI) or frequency information on the corresponding non-serving cell. In addition, when a HARQ process that the UE is using in a non-serving cell is shared with a HARQ process that the UE is using in a serving cell, the other base station reception state message may include the number of HARQ processes that the UE is using as broadcast reception in the non-serving cell, or is required to use as broadcast reception, and is transmitted by the UE to the base station. The other base station reception state message may include a preference related to whether the UE prefers to receive a broadcast service that the UE is interested in receiving or is receiving from a non-serving cell from a serving cell or from a non-serving cell. The base station that has received the other base station reception state message transmitted in step 340 may be aware of a broadcast service reception state of the UE from the non-serving cell and, on this basis, may separately set the UE to receive a specific service from the non-serving cell (350). This message may include a cell ID indicating that the UE will receive a broadcast service from a given non-serving cell, and a list of broadcast services (TMGI) that the UE is instructed to receive from the cell. The UE may receive the broadcast service from the other base station (non-serving cell) on the basis of the configuration message in step 350 (360). In an embodiment, in step 350, the list of broadcast services provided by the serving cell may be updated, and the UE may perform reception of the corresponding service from the serving base station when the serving base station provides a service that the UE is interested in. When the serving cell does not provide the broadcast service that the UE is interested in, but the corresponding broadcast service is provided by the non-serving cell, the UE may perform reception of the corresponding service from the non-serving cell.

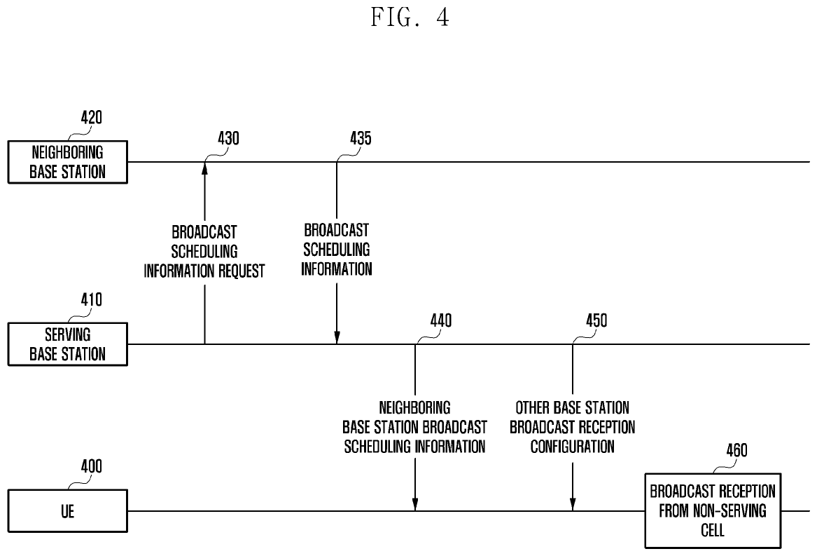

FIG. 4 is a view illustrating a method by which UE receives a broadcast service from a non-serving cell, according to an embodiment of the present disclosure.

When UE 400 is able to receive a broadcast service from a non-serving cell, a serving base station 410 may request reception of broadcast scheduling information to a base station for a corresponding non-serving cell 420, i.e., a neighboring base station (430). The neighboring base station that has received this message may transmit to the serving base station scheduling information of the broadcast service being provided by the cell of the corresponding neighboring base station (430). This message may include at least one of a list of broadcast services (TMGI) being provided by the cell of the corresponding neighboring base station, broadcast multicast radio bearer (MRB) configuration information, a G-RNTI value for broadcast reception, MCCH scheduling information, time information (slot, system frame number) at which data from each broadcast MRB is transmitted, or a packet data convergence protocol (PDCP) sequence number (SN) transmitted by the broadcast MRB. In step 430, the serving base station that has received the broadcast scheduling information of the neighboring base station may transmit all or a portion of the broadcast scheduling information of the neighboring base station to the connected UE 400 (440). This message may be transmitted in at least one format of a system information block, MCCH, RRC reconfiguration message, or other separate RRC message. In addition, the base station may set the UE capable of receiving broadcasts from a non-serving cell to receive a broadcast service from another base station (450). The message in step 450 may include a PCI or frequency value of the non-serving cell, and may include a list of broadcast services (TMGI) to be received from the non-serving cell. In an embodiment, the message in step 440 and the message in step 450 may be transmitted as a single message. On this basis, the UE may receive a broadcast service from a non-serving cell of the UE (460).

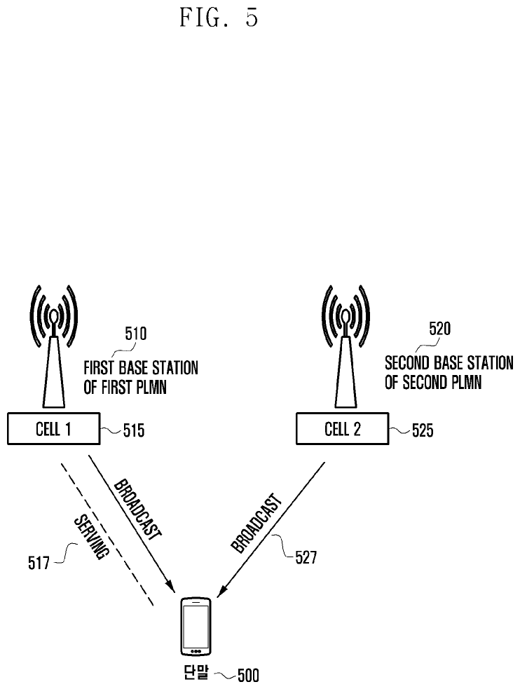

FIG. 5 is a view illustrating a method by which UE receives a broadcast service from a cell of another PLMN, according to an embodiment of the present disclosure.

The UE may be configured to include multiple radio receivers for an operation of performing transmission and reception while being simultaneously connected to multiple cells, such as carrier aggregation (CA) and dual connectivity. When the UE has such a usable receiver, the UE may also receive a message transmitted by a cell in a public land mobile network (PLMN) other than a PLMN to which the UE is currently connected, in a broadcast method. The embodiment of FIG. 5 assumes UE 500 is connected to cell 1 515 of a first base station 510 of a first PLMN (517). That is, cell 1 of the first PLMN is assumed to be a serving cell. The first base station of the first PLMN may provide a broadcast service through cell 1, in which case the UE 500 may receive broadcast configuration information from cell 1, which is a serving cell, and receive the broadcast service. However, it may be difficult for the UE to receive the broadcast service from the serving cell when the serving cell of the UE does not provide a broadcast service of interest that the UE wishes to receive, the reception of the broadcast service is not smooth due to problems such as weak reception signal and the like, or the reception of the broadcast service is de-prioritized because the reception of a unicast service has a higher priority than the reception of the broadcast service. In this case, when the UE has a usable receiver and a cell of another PLMN is detected and a cell of the other PLMN provides a broadcast service of interest that the UE wishes to receive, the UE may receive the corresponding broadcast service of interest from cell 2 of a second PLMN, which is another PLMN (527). To this end, the UE may receive broadcast configuration information of cell 2 from cell 2 of the second PLMN through a system information block or an MCCH channel. In this case, the UE may control that a portion of a receiver function is shared by unicast and broadcast reception from the serving cell and broadcast reception from the cell of the other PLMN. For example, a HARQ process and a HARQ buffer used by the UE per cell may be shared by transmission and reception operations of a serving cell and reception operation of a cell of a PLMN different from the serving cell.

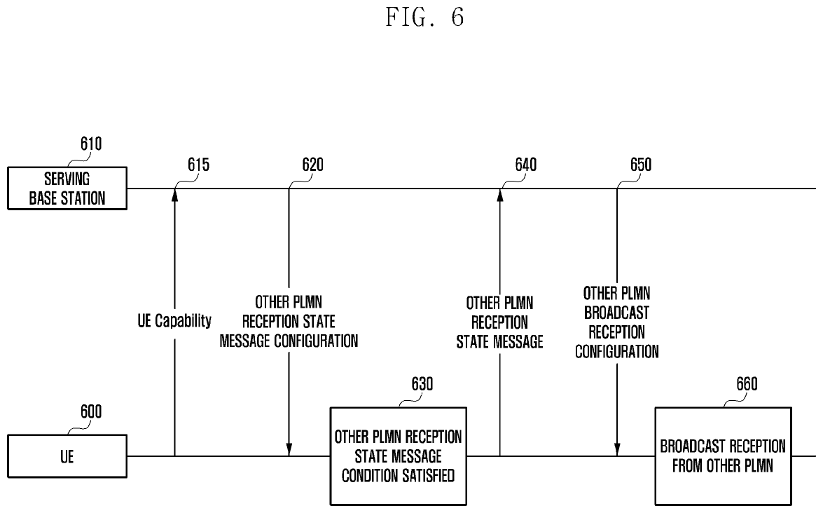

FIG. 6 is a view illustrating a method by which UE reports broadcast service information from another PLMN to a serving base station, according to an embodiment of the present disclosure.

As described in FIG. 5, when the UE has multiple radio receivers and there is a usable receiver capable of receiving a broadcast service from a cell of a PLMN different from the serving base station of the UE, the UE may receive a broadcast service of interest from the cell of another PLMN. In this case, a serving base station to which the serving cell belongs may be aware of a list of broadcast services that the UE is currently receiving or is interested in receiving by means of MII messages transmitted by the base station and the like. The serving base station may reflect this and provide the corresponding broadcast service from the serving cell. However, when the UE receives this service from the cell of the other PLMN, it may occur that the UE does not receive the broadcast service provided by the serving cell. This may be a waste of radio resources. To avoid this, the UE may transmit to the serving base station or serving cell a list of broadcast services and information on the corresponding PLMN that the UE is receiving or is interested in receiving from the cell of the other PLMN.

UE 600 may transmit to a base station 610 a UE capability message indicating that the UE is capable of receiving a broadcast service from another PLMN, such as having a receiver capable of receiving a broadcast service from a cell of a PLMN different from the serving base station of the UE (615). This message may include an indicator indicating that the UE may receive a broadcast message from the cell of another PLMN. The message may be in the format of a UE capability message, but may also be in the format of an MII message or a UE assistance information (UAI) message, depending on embodiments. The MII or UAI message may include information indicating that the broadcast service may be received from the cell of another PLMN. The base station may then request the UE to report on which broadcast service the UE is receiving from a base station of another PLMN of the UE, i.e., the cell of the other PLMN, or which broadcast service of interest the UE may receive, and the like. This message may be referred to as an “other PLMN reception state message configuration” message (620). The UE may identify, on the basis of the other PLMN reception state message configuration, that the UE is satisfied with a triggering condition of the other PLMN reception state message (630). In contrast, the UE may trigger this message without going through step 615 or step 620, when there is a broadcast message that the UE is receiving from the cell of the other PLMN, when a broadcast message of interest may be received from the cell of the other PLMN, or when the triggering condition of the other PLMN reception state message is satisfied. The UE may then transmit the other PLMN reception state message to the serving base station (640). In an embodiment, the UE may trigger this message to transmit the other PLMN reception state message when the UE has not transmitted the other PLMN reception state message to the serving base station after having entered the connected mode. In another embodiment, the UE may trigger this message to transmit the other PLMN reception state message to the serving base station when information in the previously reported other PLMN reception state message has changed. For example, when UE was receiving a broadcast message from the cell of another PLMN, and the cell is no longer able to receive the broadcast message, the UE may transmit another PLMN reception state message to a serving base station. In another embodiment, the UE may transmit another PLMN reception state message to a serving base station when the UE detects a cell of the other PLMN and there is a broadcast service from the cell of the corresponding other PLMN that the UE is interested in receiving, or when the UE has received a broadcast service from the cell of the corresponding other PLMN. The other PLMN reception state message may be transmitted in the form of an MII message, UE assistance information or another RRC message. This other PLMN reception state message may include a list of broadcast services that are being received by the base station of the other PLMN or a list of broadcast services that are available for reception by the base station of the other PLMN. The list of broadcast services may be referred to as a temporary mobile group identity (TMGI). In order to indicate that the corresponding broadcast message is being received or is available for reception by the cell of the other PLMN, the other PLMN reception state message may include an identity of the other PLMN (PLMN identity) and a cell identity of the corresponding cell (cell identity). The cell identity may be configured with a physical cell identity (PCI) or frequency information on the cell of the corresponding PLMN. In addition, when a HARQ process that the UE is using in the cell of the other PLMN is shared with a HARQ process that the UE is using in a serving cell, the other PLMN reception state message may include the number of HARQ processes that the UE is using as broadcast reception in the cell of the other PLMN, or is required to use as broadcast reception, and is transmitted by the UE to the base station. The other PLMN reception state message may also include preference information that includes at least one information of whether the UE prefers to receive a broadcast service that the UE is interested in receiving or is receiving from the cell of the other PLMN from a serving cell, from a non-serving cell of the PLMN to which the UE is connected, or from the cell of the other PLMN. When the base station has received the other PLMN reception state message transmitted in step 640, the base station may be aware of a broadcast service reception state of the UE from the cell of the other PLMN and, on this basis, may separately set the UE to receive a specific service from the cell of the other PLMN (650). This message may include a PLMN ID indicating that the UE will receive a broadcast service from a given cell of another PLMN, a cell ID, and a list of broadcast services (TMGI) that the UE is instructed to receive from the cell. The UE may receive the broadcast service from the cell of the other PLMN on the basis of the configuration message in step 650 (660). In an embodiment, in step 650, the list of broadcast services provided by the serving cell may be updated, and the UE may perform reception of the corresponding service from the serving base station when the serving base station provides a service that the UE is interested in. When the serving cell does not provide the broadcast service that the UE is interested in, but the corresponding broadcast service is provided by the cell of the other PLMN, the UE may perform reception of the corresponding service from the cell of the other PLMN.

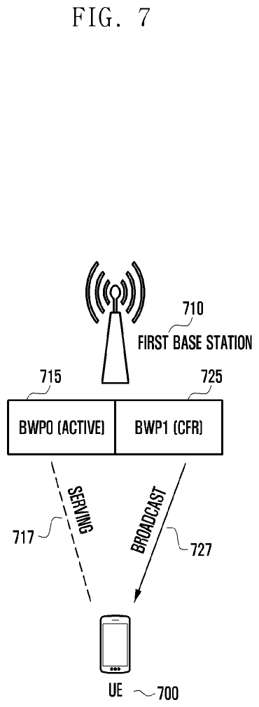

FIG. 7 is a view illustrating a method by which UE receives a broadcast service from an inactive BWP according to an embodiment of the present disclosure.

The UE may be configured to include multiple radio receivers for an operation of performing transmission and reception while being simultaneously connected to multiple cells, such as carrier aggregation (CA) and dual connectivity. The UE may also receive a message transmitted by an inactive bandwidth part (BWP) that is not active in a broadcast method when there is a usable receiver as described above. The embodiment of FIG. 7 assumes that UE 700 is connected to BWP0 715 of a first base station 710 that is a current active BWP (717). That is, it is assumed that the UE performs data transmission and reception from BWP0, which is an active BWP. When the first base station provides a broadcast service through BWP0, the UE 700 may receive broadcast configuration information from BWP 0, which is an active BWP, and receive the broadcast service. However, the UE may have difficulty receiving the broadcast service from the active BWP when the active BWP of the UE does not provide a broadcast service of interest that the UE wishes to receive, or when the reception of the broadcast service is de-prioritized because the reception of a unicast service has a higher priority than the reception of the broadcast service. In this case, when there is a receiver available to the UE, and an inactive BWP provides a broadcast service of interest that the UE wishes to receive, the UE may receive the corresponding broadcast service of interest from the inactive BWP (727). To this end, the UE may receive broadcast configuration information of the inactive BWP through a system information block or an MCCH channel. In this case, the UE may control that a portion of a receiver function is shared by unicast and broadcast reception from the active BWP and broadcast reception from the inactive BWP. For example, a HARQ process and a HARQ buffer used by the UE per cell may be shared by transmission and reception operations of the active BWP and reception operation of the inactive BWP.

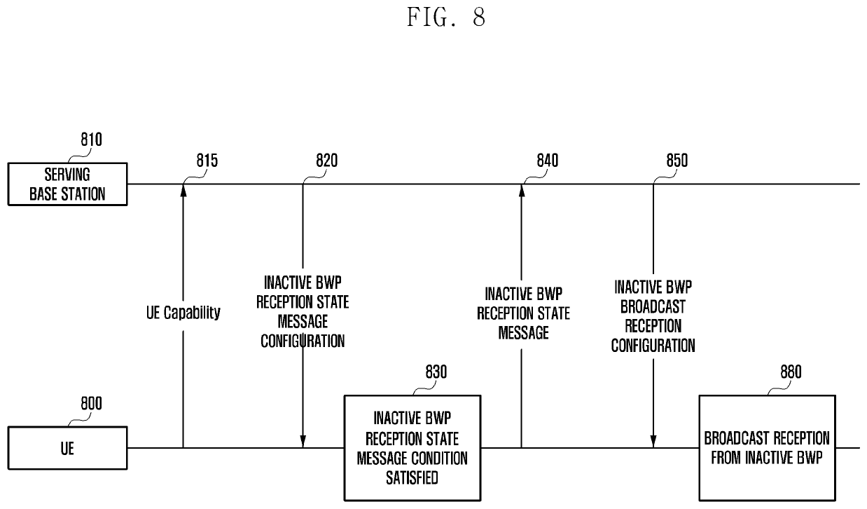

FIG. 8 is a view illustrating a method by which UE reports broadcast service information from an inactive BWP to a serving base station, according to an embodiment of the present disclosure.

As described in FIG. 7, when the UE has multiple radio receivers and there is a usable receiver that is capable of receiving a broadcast service from an inactive BWP that is not currently an active BWP but provides a broadcast service, the UE may receive a broadcast service of interest from the inactive BWP. The BWP to which the broadcast service is provided may be a BWP that includes an Initial BWP for an initial access of the UE. In this case, a serving base station of the UE may be aware of a list of broadcast services that the UE is currently receiving or is interested in receiving by means of MII messages transmitted by the base station and the like. The serving base station may reflect this and provide the corresponding broadcast service from the active BWP of the serving cell. However, when the UE receives the corresponding service from the inactive BWP, it may occur that the UE does not receive the broadcast service provided by active BWP. This may be a waste of radio resources. To avoid this, the UE may transmit to the serving base station or serving cell a list of broadcast services that the UE is receiving or is interested in receiving from the inactive BWP.

UE 800 may transmit to a base station 810 a UE capability message indicating that the UE is capable of receiving a broadcast service from an inactive BWP, such as having a receiver capable of receiving a broadcast service from an inactive BWP (815). This message may include an indicator indicating that the UE may receive a broadcast message from the inactive BWP. The message may be in the format of a UE capability message, but may also be configured in the form of an MII message or a UE assistance information (UAI) message, depending on embodiments. The MII or UAI message may include information indicating that the broadcast service may be received from the inactive BWP. The base station may then request the UE to report on which broadcast service the UE is receiving from the inactive BWP, or which broadcast service of interest the UE may receive, and the like. This message may be referred to as an “inactive BWP reception state message configuration” message (820). The UE may identify, on the basis of the inactive BWP reception state message configuration, that the UE is satisfied with a triggering condition of the inactive BWP reception state message (830). However, the UE may trigger this message without going through step 815 or step 820, when there is a broadcast message that the UE is receiving from the inactive BWP, when a broadcast message of interest may be received from the inactive BWP, or when the triggering condition of the inactive BWP reception state message is satisfied. The UE may then transmit the inactive BWP reception state message to the serving base station (840). In an embodiment, the UE may trigger this message to transmit the inactive BWP reception state message when the UE has not transmitted the inactive BWP reception state message to the serving base station after having entered the connected mode. In another embodiment, the UE may trigger this message to transmit the inactive BWP reception state message to the serving base station when information in the previously reported inactive BWP reception state message has changed. For example, when UE was receiving a broadcast message from the inactive BWP, and the inactive BWP is no longer able to receive the broadcast message, the UE may transmit the inactive BWP reception state message to a serving base station. In another embodiment, the UE may transmit the inactive BWP reception state message to a serving base station when the UE detects an inactive BWP and there are broadcasts of interest that the UE wishes to receive from the corresponding inactive BWP, or when the UE has received a broadcast service from the corresponding inactive BWP. The inactive BWP reception state message may be transmitted in the form of an MII message, UE assistance information or another RRC message. This inactive reception state message may include a list of broadcast services that are being received by the inactive BWP or a list of broadcast services that are available for reception by the inactive BWP. The list of broadcast services may be referred to as a temporary mobile group identity (TMGI). In order to indicate that an inactive BWP in a given cell is receiving, or is able to receive, the corresponding broadcast message, the inactive reception state message may include a cell identity to which the inactive BWP belongs. The cell identity may be a physical cell identity (PCI), a SCell or PSCell, a cell identity of a PCell, or frequency information of the corresponding inactive BWP. In addition, when a HARQ process that the UE is using in the inactive BWP is shared with a HARQ process that the UE is using in the active BWP, the inactive BWP reception state message may include the number of HARQ processes that the UE is using as broadcast reception in the cell of the inactive BWP, or is required to use as broadcast reception, and is transmitted by the UE to the base station. The inactive BWP reception state message may include a preference related to whether the UE prefers to receive a broadcast service that the UE is interested in receiving or is receiving from the inactive BWP from the active BWP or from the inactive BWP. The base station that has received the inactive BWP reception state message transmitted in step 840 may be aware of a broadcast service reception state of the UE from the inactive BWP and, on this basis, may separately set the UE to receive a specific service from the inactive BWP (850). This message may include a cell ID indicating that the UE will receive a broadcast service from an inactive BWP in a given cell and a list of broadcast services (TMGI) that the UE is instructed to receive from the inactive BWP of the cell. The UE may receive the broadcast service from an inactive base station on the basis of the configuration message in step 850 (860). In an embodiment, in step 850, the list of broadcast services provided by the active BWP may be updated, and the UE may perform reception of the corresponding service from the active BWP when the active BWP provides a service that the UE is interested in. When the active BWP does not provide the broadcast service that the UE is interested in, but the corresponding broadcast service is provided by the inactive BWP, the UE may perform reception of the corresponding service from the inactive BWP.

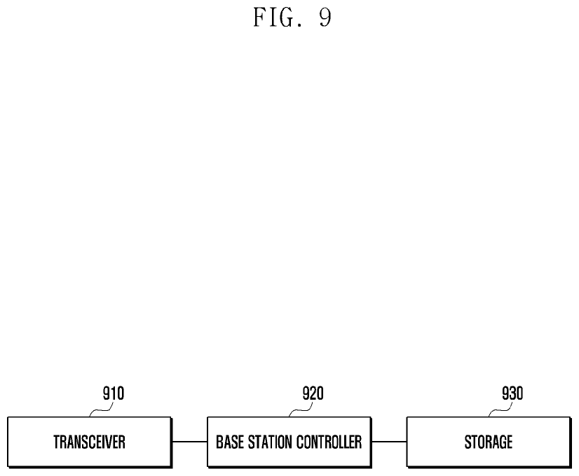

FIG. 9 is a view illustrating a structure of a base station according to an embodiment of the present invention.

With reference to FIG. 9, the base station may include a transceiver 910, a controller 920, and storage 930. In the present disclosure, the controller 920 may be defined as a circuit, an application specific integrated circuit (ASIC), or at least one processor. The transceiver 910 may transmit and receive signals to and from other network entities For example, the transceiver 910 may transmit system information to the UE, and may transmit a synchronization signal or a reference signal. The controller 920 may control overall operation of the base station as proposed in the present invention. For example, the controller 920 may control signal flows between the blocks to perform the operations according to the above-described flowcharts. The storage 930 may store at least one of information transmitted and received through the transceiver 910 or information generated through the controller 920.

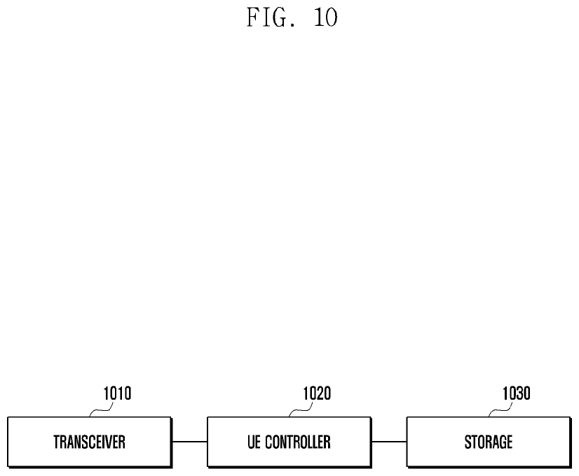

FIG. 10 is a view illustrating a structure of UE according to an embodiment of the present invention.

With reference to FIG. 10, the UE may include a transceiver 1010, a controller 1020, and storage 1030. In the present disclosure, the controller may be defined as a circuit, an application specific integrated circuit (ASIC), or at least one processor. The transceiver 1010 may transmit and receive signals to and from other network entities For example, the transceiver 1010 may receive system information from the base station, and may receive a synchronization signal or a reference signal. The controller 1020 may control overall operation of the UE as proposed in the present invention. For example, the controller 1020 may control signal flows between the blocks to perform the operations according to the above-described flowcharts. The storage 1030 may store at least one of information transmitted and received through the transceiver 1010 or information generated through the controller 1020.

The embodiments of the present disclosure disclosed in the present specification and illustrated in the drawings are provided as particular examples just for easily explaining the technical contents of the present disclosure and helping understand the present disclosure, but not intended to limit the scope of the present disclosure. It is obvious to those skilled in the art to which the present invention pertains that other modified embodiments may be carried out based on the technical spirit of the present invention in addition to the exemplary embodiments disclosed herein.

1-15. (canceled)

16. A method performed by a user equipment (UE) in a wireless communication system, the method comprising:
transmitting, to a base station, UE capability information indicating that the UE supports multicast and broadcast service (MBS) broadcast reception on a non-serving cell;
receiving, from the base station, information related to a transmission of a MBS interest indication (MII) message for the MBS broadcast reception on the non-serving cell; and
transmitting, to the base station, the MII message including information on a broadcast service which the UE is receiving from the non-serving cell or the UE is interested to receive from the non-serving cell,
wherein the information on the broadcast service includes a broadcast frequency of the broadcast service which the UE is receiving from the non-serving cell or the UE is interested to receive from the non-serving cell.

17. The method of claim 16, wherein the information related to the transmission of the MII message includes information on whether reporting of information on a broadcast service from a non-serving cell is allowed for the UE.

18. The method of claim 17, wherein the information related to the transmission of the MII message is received via a system information block (SIB).

19. The method of claim 16, wherein the non-serving cell corresponds to an inactive bandwidth part (BWP) that is different from an active BWP corresponding to a serving cell.

20. A method performed by a base station in a wireless communication system, the method comprising:
receiving, from a user equipment (UE), UE capability information indicating that the UE supports multicast and broadcast service (MBS) broadcast reception on a non-serving cell;
transmitting, to the UE, information related to a transmission of a MBS interest indication (MII) message for the MBS broadcast reception on the non-serving cell;
receiving, from the UE, the MII message including information on a broadcast service which the UE is receiving from the non-serving cell or the UE is interested to receive from the non-serving cell, wherein the information on the broadcast service includes a broadcast frequency of the broadcast service which the UE is receiving from the non-serving cell or the UE is interested to receive from the non-serving cell.

21. The method of claim 20, wherein the information related to the transmission of the MII message includes information on whether reporting of information on a broadcast service from a non-serving cell is allowed for the UE.

22. The method of claim 21, wherein the information related to the transmission of the MII message is transmitted via a system information block (SIB).

23. The method of claim 20, wherein the non-serving cell corresponds to an inactive bandwidth part (BWP) that is different from an active BWP corresponding to a serving cell.

24. A user equipment (UE) operating in a wireless communication system, the UE comprising:
a transceiver; and
a controller configured to:
transmit, to a base station via the transceiver, UE capability information indicating that the UE supports multicast and broadcast service (MBS) broadcast reception on a non-serving cell;
receive, from the base station via the transceiver, information related to a transmission of a MBS interest indication (MII) message for the MBS broadcast reception on the non-serving cell, and
transmit, to the base station via the transceiver, the MII message including information on a broadcast service which the UE is receiving from the non-serving cell or the UE is interested to receive from the non-serving cell, wherein the information on the broadcast service includes a broadcast frequency of the broadcast service which the UE is receiving from the non-serving cell or the UE is interested to receive from the non-serving cell.

25. The UE of claim 24, wherein the information related to the transmission of the MII message includes information on whether reporting of information on a broadcast service from a non-serving cell is allowed for the UE.

26. The UE of claim 25, wherein the information related to the transmission of the MII message is received via a system information block (SIB).

27. The UE of claim 24, wherein the non-serving cell corresponds to an inactive bandwidth part (BWP) that is different from an active BWP corresponding to a serving cell.

28. A base station operating in a wireless communication system, the base station comprising:
a transceiver; and
a controller configured to:
receive, from a user equipment (UE) via the transceiver, UE capability information indicating that the UE supports multicast and broadcast service (MBS) broadcast reception on a non-serving cell, and
transmit, to the UE via the transceiver, information related to a transmission of a MBS interest indication (MII) message for the MBS broadcast reception on the non-serving cell, and
receive, from the UE via the transceiver, the MII message including information on a broadcast service which the UE is receiving from the non-serving cell or the UE is interested to receive from the non-serving cell, wherein the information on the broadcast service includes a broadcast frequency of the broadcast service which the UE is receiving from the non-serving cell or the UE is interested to receive from the non-serving cell.

29. The base station of claim 28, wherein the information related to the transmission of the MII message includes information on whether reporting of information on a broadcast service from a non-serving cell is allowed for the UE.

30. The base station of claim 29, wherein the information related to the transmission of the MII message is transmitted via a system information block (SIB).

31. The base station of claim 29, wherein the non-serving cell corresponds to an inactive bandwidth part (BWP) that is different from an active BWP corresponding to a serving cell.
